(19) United States
(12) Patent Application Publication
(10) Pub. No.: US 2005/0007118 A1
(43) Pub. Date: Jan. 13, 2005

(54) Micromachined alkali-atom vapor cells and method of fabrication

(76) Inventors: John Kitching, Boulder, CO (US); Leo Hollberg, Boulder, CO (US); Li-Anne Liew, Westminister, CO (US); Svenja Knappe, Boulder, CO (US); John Moreland, Louisville, CO (US); Volodja Velichanski, Moscow (RU); Hugh Robinson, Superior, CO (US)

Correspondence Address: BUTZEL LONG, 350 SOUTH MAIN STREET, SUITE 300, ANN ARBOR, MI, 48104, US

(21) Appl. No.: 10/821,236

(22) Filed: Apr. 8, 2004

Related U.S. Application Data
(60) Provisional application No. 60/461,692, filed on Apr. 9, 2003.

(51) Int. Cl. G01V 3/00

(52) U.S. Cl. 324/464

(57) ABSTRACT

A method of fabricating compact alkali vapor filled cells that have volumes of 1 cm³ or less that are useful in atomic frequency reference devices such as atomic clocks. According to one embodiment the alkali vapor filled cells are formed by sealing the ends of small hollow glass fibers. According to another embodiment the alkali vapor filled cells are formed by anodic bonding of glass plates to silicon wafers to seal the openings of holes formed in the silicon wafers. The anodic bonding method of fabricating the alkali vapor filled cells enables the production of semi-monolithic integrated physics packages of various designs.

### RELATED APPLICATION

The present application is based upon U.S. Provisional Patent Application Ser. No. 60/461,692, filed Apr. 9, 2003 to which priority is claimed under 35 U.S.C. §120.

### TECHNICAL FIELD

The present invention relates to compact gas-filled cells. More particularly, the present invention relates to methods of fabricating compact hollow cells and filling the compact cells with alkali-atom vapor with the optional inclusion of a buffer gas or gases.

### BACKGROUND ART

Atomic clocks are utilized in various systems which require extremely accurate and stable frequencies, such as in bistatic radars, GPS (global positioning system) and other navigation and positioning systems. Atomic clocks are also used in communications systems, cellular phone systems and for conducting various types of scientific experiments.

One type of atomic clock utilizes a cell containing an active medium such as cesium (or rubidium) vapor. The alkali vapor cell functions as a container for atoms that have natural resonant frequencies when irradiated with optical energy at a given frequency/wavelength. Light from an optical source pumps the atoms of the vapor from a ground state to a higher state from which they fall to a state which is at a hyperfine frequency different from the initial ground state. A microwave signal can then be applied to the vapor cell and an oscillator controlling the microwave signal can be tuned to a particular frequency so as to repopulate the initial ground state. In this manner a controlled amount of the light is propagated from the cell and detected by means of a photodetector.

By examining the output of the photodetector, a control means provides various control signals to the oscillator to ensure that the wavelength of the propagated light and microwave frequency are precisely controlled, e.g. so that the microwave input frequency and hyperfine wavelength frequency are locked. The oscillator thereafter provides a highly accurate and stable frequency output signal for use as a frequency standard or atomic clock.

The current method of fabricating atom vapor cells is based on conventional glass-blowing techniques. In these methods, the cell preform is typically made by fusing glass windows onto a glass tube with a fill-hole in the side. A filling tube is attached using a torch and the cell is then attached to a vacuum system for cleaning and filling.

There is a need, both in the military and civilian sectors, for an ultra small, completely portable, highly accurate and extremely low power atomic clocks. In many applications such atomic clocks must operate continuously for 24 hours per day to perform useful functions. For this reason and the desire to allow battery powered operation, power requirements approaching 100 milliwatts, or less, are desirable for military and many civilian uses.

The non-electronic portion of an atomic clock, often referred to as the physics package, can in some cases be the limiting factor that determines the size, low power capabilities and ultimate low cost of the final product.

It is a primary object of the present invention to provide novel designs and fabrication methods that will allow constructions of very compact alkali atom vapor cells (volumes less than 1/100 of previous state of the art) that can be integrated into physics package apparatus for atomic clocks, magnetometers and other applications including atomic physics related to spectroscopy.

### DISCLOSURE OF THE INVENTION

According to various features, characteristics and embodiments of the present invention which will become apparent as the description thereof proceeds, the present invention provides a design and method of fabricating compact cells containing alkali atom vapor which involves the following steps:
a) forming an cell having a volume of 1 cm³ or less and an opening therein;
b) filling the cell with alkali atoms;
c) filling the cell with suitable buffer gas or gases when appropriate; and
d) sealing the opening of the cell.

The present invention further provides a physics package for an atomic frequency reference that comprises an alkali vapor filled cell having a volume of 1 cm³ or less, which alkali vapor filled cell is produced by the steps of:
a) forming an cell having a volume of 1 cm³ or less and an opening therein;
b) filling the cell with alkali atoms and possibly buffer gas as may be appropriate; and
c) sealing the opening of the cell.

### BRIEF DESCRIPTION OF DRAWINGS

The present invention will be described with reference to the attached drawings which are given as non-limiting examples only, in which:

FIG. 1 is a schematic of a process for sealing the end of a hollow core fiber using a laser according to one embodiment of the present invention.

FIG. 2 depicts a hollow fiber with one end sealed according to the present invention.

FIG. 3a is a schematic of an alkali vapor cell fabricated from a hollow fiber by the laser heating method depicted in FIG. 1 and showing lenses formed on the ends of the cell and the path of optical propagation of the resonant radiation.

FIG. 3b is a photograph of the alkali vapor cell similar to FIG. 3a that is filled with an alkali metal and a buffer gas and which has an outside diameter of 1.6 mm and an inside diameter of 1.2 mm.

FIG. 4 is a schematic of a process for creating a small hole in the side of a hollow core fiber using a laser and internal pressure variation.

FIG. 5 is a schematic of a process for sealing a glass tube to the side of a cell preform for filling the cell preform with a desired chemical.

FIG. 6 depicts a cell that has been filled and sealed using the process depicted in FIG. 5.

FIG. 7a is a graph of the optical absorption spectrum of Cs in the gas phase stored in a small cell similar to the cell shown in FIGS. 3b and 6.

FIG. 7b is a graph of the dark-line microwave resonance that is suitable for used in an atomic frequency reference of the same cell.

FIGS. 8a-8d depict the steps in a process for fabricating micromachined vapor filled glass and silicon cells according to one embodiment of the present invention.

FIG. 9 is a graph of the optical absorption spectrum of a Cs cell fabricated in an anaerobic chamber.

FIG. 10 is a graph the optical absorption spectrum of a cell that was filled with Cs using a chemical reaction method according to the present invention.

FIG. 11a depicts a design of a physics package for an atomic clock according to one embodiment of the present invention.

FIG. 11b depicts the physics package for an atomic clock of FIG. 11a in an exploded view.

### BEST MODE FOR CARRYING OUT THE INVENTION

The present invention is directed to compact gas-filled cells. More particularly, the present invention relates to methods of fabricating compact hollow cells and filling the compact cells with alkali-atom vapor.

According to one embodiment of the present invention a process has been developed for fabricating small, sealed glass cells from hollow-core fibers. These cells can be filled with a vapor of alkali atoms, as well as a controlled environment such as a buffer gas. According to one fabrication process, light from a suitable laser such as a carbon-dioxide (CO₂) laser at a wavelength of 10 μm is focused onto the tip of a hollow-core glass fiber. Energy from the laser is absorbed by the glass, melting it, and sealing the interior volume of the fiber in an airtight manner. Alkali atoms in a vacuum or a buffer-gas environment can be deposited into the fiber before sealing, confining the atoms/buffer gas in a controlled environment inside the walls of the fiber. In this way, compact cells containing a vapor of alkali atoms can be made. In addition to sealing the vapor cells, this fabrication method forms hemispherical glass beads at the ends of the fibers which can be used as lenses for efficiently coupling light into the fibers to probe the atoms such as indicated in FIG. 3a.

According to another embodiment of the present invention a process has been developed for fabricating small vapor filled glass and silicon cells are made using anodic bonding of glass and silicon (Si) wafers, in which elevated temperatures and applied high voltages are used to bond the two materials together. Alkali atoms can be introduced into the glass/Si cells in several ways such as: 1) direct injection of material; 2) a chemical reaction; and 3) deposition by an atomic beam. These processes can be performed in a controlled non-reactive environment such as an anaerobic chamber, or in a vacuum chamber. In addition to being compact, the glass/Si cells lend themselves easily to wafer-level assembly of physics packages for atomic frequency references.

According to the present invention vapor-filled cells with volumes much less that 1 cm³ can be fabricated and used to confine alkali atoms (and in come cases buffer gases) in miniature vapor cell atomic clocks or magnetometers.

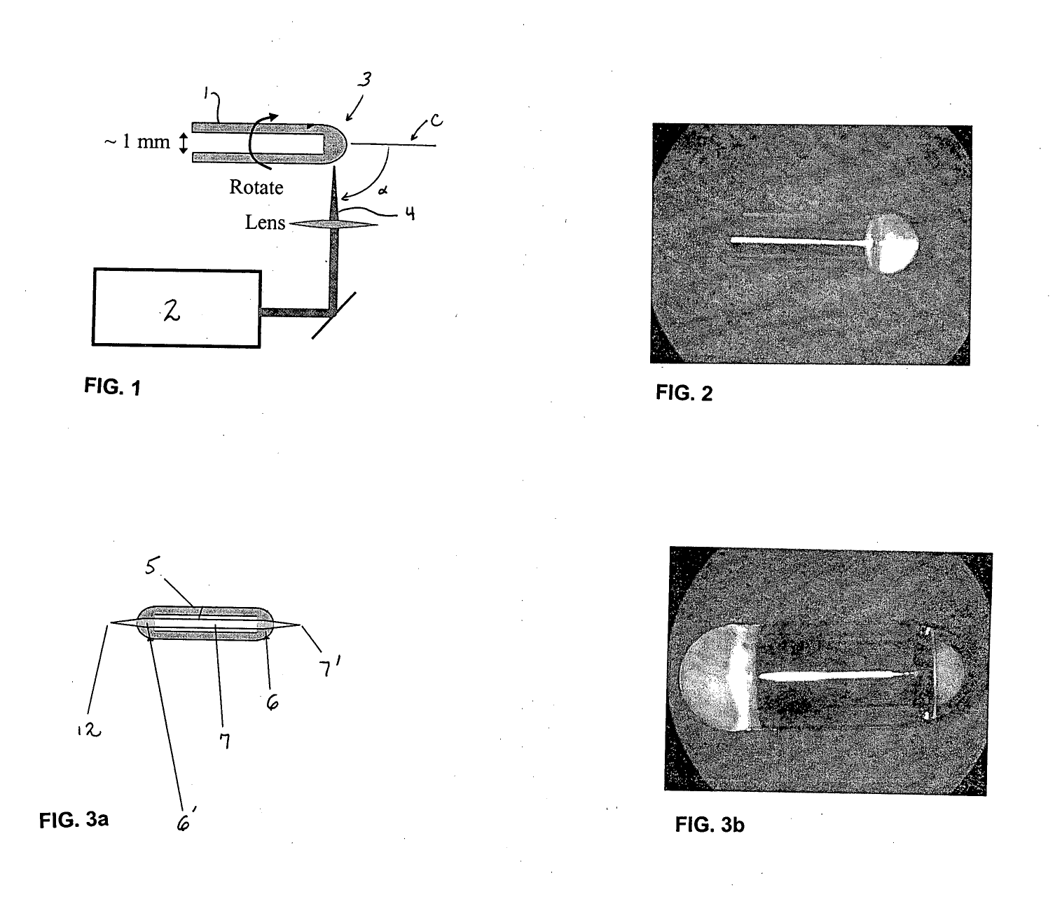

FIG. 1 is a schematic of a process for sealing the end of a hollow core fiber using a laser according to one embodiment of the present invention. The hollow core fiber 1 can be made of Pyrex, fused silica or other materials that absorb laser light. The fiber 1 is rotated about its central axis “c” to allow for uniform heating. Light from a laser source 2 is focused onto the tip 3 of the fiber 1. During the course of the present invention it was determined that the laser beam of light 4 should be focused on the fiber 1 at an angle α of between about 30° to about 150° measured rearward from an extension of the center line “c” beyond the tip 3 of the fiber 1 as shown in FIG. 1. Smaller angles of from about 450 to about 1350 are particularly suitable with angles of greater than about 90°, e.g. about 1350 having demonstrated good results. The laser beam 4 should have a power that is sufficient to melt the fiber 1 in a controlled manner so as to prevent the formation of a “cusp” (discussed below) and prevent uncontrolled melting and flow of the material from which the fiber 1 is made. In the case of Pyrex and fused silica, a CO₂ laser beam having a power of from about 5 to 20 W was focused on a spot roughly 100 μm in diameter. Since light at the CO₂ laser wavelength (10 μm) is strongly absorbed by the fiber 1, the temperature at the tip 3 of the fiber 1 first rises to near the melting point and the glass begins to deform. Drawn towards the fiber axis by surface tension, the walls of the fiber 1 near the tip 3 eventually collapse on themselves and melt together, sealing the end of the fiber 1 shut. This process typically occurs within several tens of seconds to one minute, depending on the power level and strength of focusing of the laser. Eventually, a hemispherical glass bead is formed at the end of the fiber 1, with a radius roughly equal the outside radius of the original fiber 1. Such hemispherical glass beads can be used as lenses on one or both ends of a vapor cell fabricated from a fiber as discussed below. FIG. 2 depicts a hollow fiber with one end sealed according to the present invention.

FIG. 3a is a schematic of an alkali vapor cell fabricated from a hollow fiber by the laser heating method depicted in FIG. 1 and showing lenses formed on the ends of the cell and the path of optical propagation of the resonant radiation. FIG. 3b is a photograph of the alkali vapor cell similar to FIG. 3a that is filled with an alkali metal and a buffer gas and which has an outside diameter of 1.6 mm and an inside diameter of 1.2 mm. FIG. 3a depicts windows or lenses 6, 6′ that are fabricated on a cell 5 by melting a glass fiber tube 1 with laser light 4. The windows or lenses 6, 6′ can be used to manipulate a light beam 7 from a source 7′ and provide a convenient way of getting the light into and out of the cell 5. The lenses 6, 6′ comprise curved surfaces formed by beads of glass which seal the end of the cell and act as lenses. Lens 6 can be used, for example, to collimate a beam of light from a small source such as a laser so that the light beam travels in a single direction inside the cell. The window or lens 6′ on the other side or the cell can be used to refocus the light onto a photodetector 12. Thus this fiber sealing method can be used to simultaneously seal the cell 5 and provide lenses 6, 6′ for the entry and exit of a light beam 7.

During the course of the present invention it has been determined that the controlling the power level of the laser could mitigate two potential problems which might otherwise occur. If the power level is too low, a sort of “cusp” can be formed within hemispherical bead. This cusp can allow gas to pass between the outside and the inside of the fiber volume, preventing the seal from becoming airtight. If the power level is too high, gas bubbles can form inside the bead, which scatter light passing through the glass and reduce the effectiveness of the bead as a lens for coupling light into the fiber. It was determined that the formation of bubbles could be avoided by positioning the rotating fiber tip away from the beam waste of the laser, i.e. at angles greater that 90° as depicted in FIG. 1.

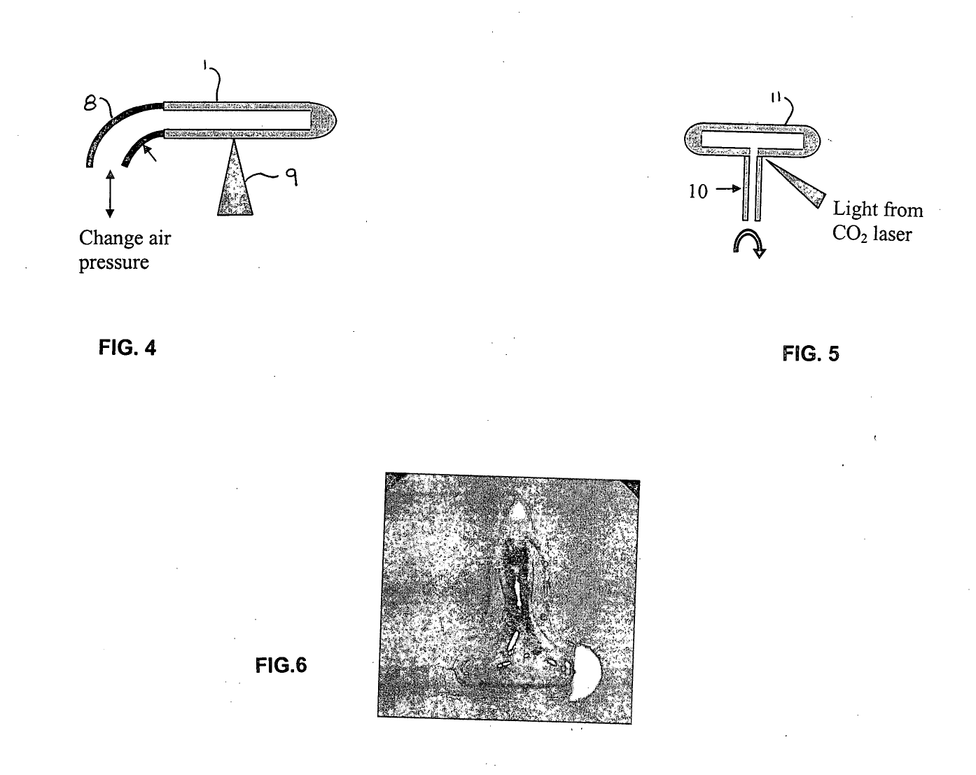

As indicated above, alkali atoms and buffer gases as appropriate can be introduced into the cells in several ways. The atoms can be simply inserted through the open end of the fiber as shown in FIG. 1 before it is sealed using the laser as described above. Alternatively, small holes can be created in the wall of the fiber, and can be used to attach a second hollow-core fiber to form a T-junction. FIG. 4 is a schematic of a process for creating a small hole in the side of a hollow core fiber using a laser and internal pressure variation. In the method depicted in FIG. 4, the fiber 1 is not rotated, but held still. A tube 8 is attached to the open end of the fiber 1 to allow the fiber's internal air pressure to be changed (for example, by the operator applying pressure into the rubber tube). A laser beam 9 is focused in a small diameter on the wall of the fiber 1 to soften the glass at that location. The air pressure in the fiber 1 is then altered between above and below atmospheric pressure, thinning the glass in the vicinity of the laser focus and eventually breaking a hole in the fiber wall, with a final strong increase in the inside pressure. Holes made in this manner can have diameters as small as 100 μm or less. In a specific example, a hole was made in a Pyrex tube using a CO₂ laser at a power of 10 W which was focused to a diameter of about 500 μm. Holes can also be made without changing the internal pressure in the fiber (if the process is carried out in a vacuum) by focusing the laser beam more tightly (diameter 100 μm).

The processes of the present invention can be used to create alkali vapor cells. For example, during the course of the present invention cells were fabricated and filled with alkali atoms as will now be described. First, one end of a 5 cm long Pyrex fiber was sealed with a CO₂ laser using the process depicted in FIG. 1. Thereafter, a hole was formed in the side wall, roughly 1 mm from the sealed end of the fiber using the process depicted in FIG. 3. The fiber was then cut to a length of 2-3 mm and the remaining end of the fiber was sealed using the process depicted in FIG. 1. The resulting cell preform was sealed at both ends and had a hole formed in the side wall which allowed for the attachment of a filling tube.

A filling tube was attached to the cell preform by placing a second hollow-core fiber perpendicular to the first, with hole at the end of the second fiber coincident with the hole in the side wall of the first. The two fibers were then fused together by heating the junction between the two fibers with laser light while simultaneously rotating the two pieces together. The filling tube is then attached to a conventional cell-filling manifold and alkali metal can be distilled into the cell. The cell is thereafter back-filled with an appropriate pressure of buffer gas before the filling tube was sealed, creating an alkali metal vapor-filled cell. FIG. 5 is a schematic of the process used so seal a glass fill tube 10 to the side of the cell perform 11 for filling the cell perform with desired atoms. The fill tube 10 can be sealed using a laser, e.g. CO₂ laser (or using a micro-torch). FIG. 6 depicts a cell that has been filled and sealed using the process depicted in FIG. 5.

According to another method of filling hollow core fiber cells with alkali metals according to the present invention, one end of the cell is first sealed using the process depicted in FIG. 1. The hollow core fiber is then cut to a desired length and placed inside a vacuum system containing either a vapor or a beam of alkali atoms and into which a buffer gas can be introduced. Alkali metal is deposited inside the fiber by either placing the fiber opening facing the atomic beam or by allowing the alkali atoms in the vapor phase to diffuse into the fiber. The fiber may be cooled during this phase of the process, to cause the alkali atoms to stick to the interior walls of the fiber. A buffer gas is then introduced to the chamber, filling the fiber tube. Thereafter, the other end of the fiber is sealed shut using the process depicted in FIG. 1. This method seals the alkali atoms and buffer gas inside the cell and creates lenses on either end for coupling light into the cell. Alternatively, several cells can be made from one long cell by using the laser heating method, with a distinguishing feature being the formation of lenses on the ends of the cells.

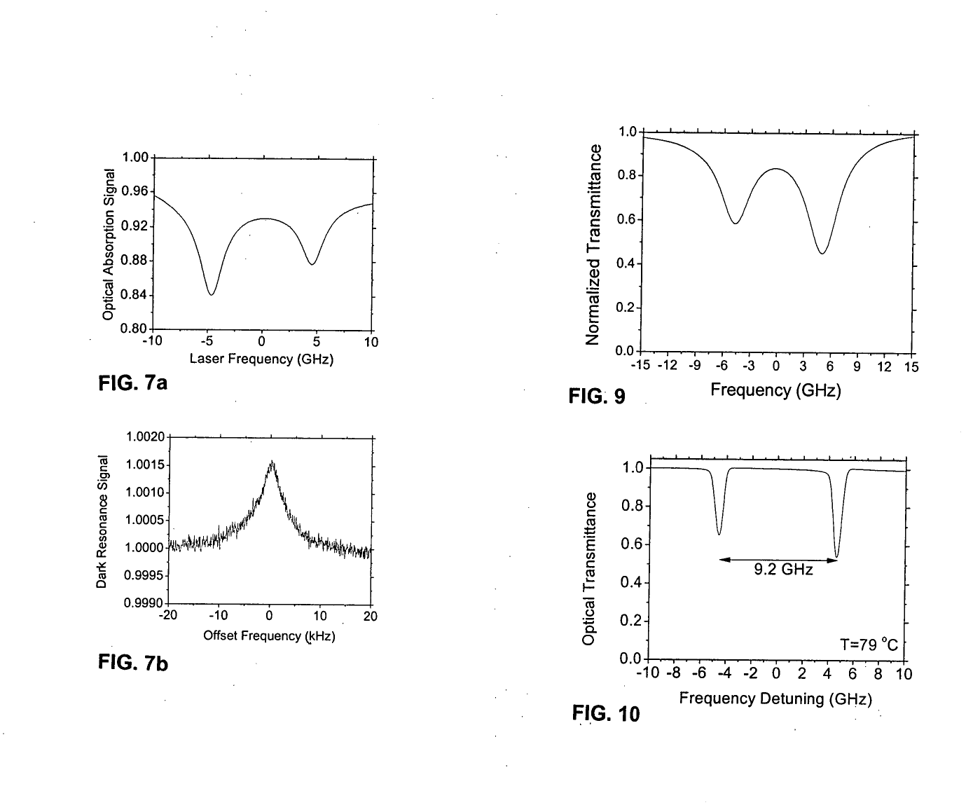

The success of the sealing technique has been proven by the observation of optical and microwave resonances from atoms contained inside the cell. FIG. 7a is a graph of the optical absorption spectrum of Cs in the gas phase stored in a small cell similar to the cell shown in FIG. 6. FIG. 7b is a graph of the dark-line microwave resonance that is suitable for used in an atomic frequency reference of the same cell. The broad width of this resonance indicates that a buffer gas is present in the cell. The dark-line microwave resonance in FIG. 7b would be suitable for an atomic frequency reference or magnetometer based on this small cell.

The extreme miniaturization of cells fabricated according to the present invention allow for simplification of optical designs of compact frequency references or magnetometers. The processes described above have been used to produce cells with inside diameters about 1 mm, which is considerably smaller than can be achieved with conventional glass-blowing techniques. The fabrication of even smaller cell structures, with diameters well below 1 mm, is feasible using the methods of the present invention.

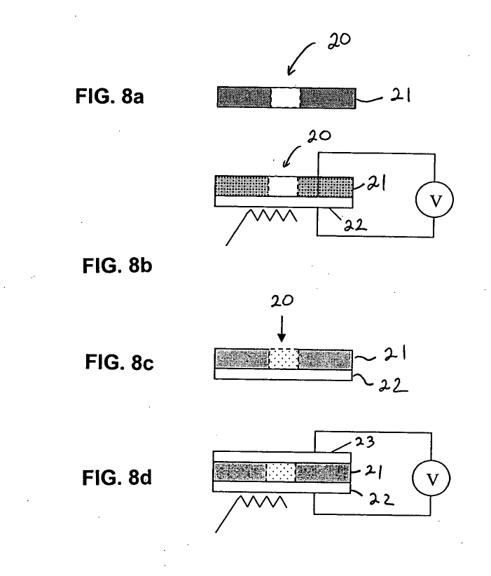

According to another embodiment of the present invention small vapor filled glass and silicon cells are fabricated by anodically bonding of silicon and Pyrex or (or another material) in the structure of wafers using high voltage applied at elevated temperatures. FIGS. 8a-8d depict the steps in a process for fabricating micromachined vapor filled glass and silicon cells according to one embodiment of the present invention.

Anodic bonding is an established and well-known process in silicon micromachining that has been used to make micro-sensors such as airbag accelerometers. According to the present invention holes 20 are created in a silicon wafer 21 that has both sides polished as shown in FIG. 8a. The holes 20 will eventually form the interior volume of cells that will be created. The location of the holes 20 in the silicon wafer 21 are patterned using standard photolithographic techniques in a clean room and are etched using either KOH or deep reactive ion etching. Both the patterning and etching are well-known processes used in silicon micromachining and commercial systems are available for these processes. Following etching, the silicon wafer 21 can be divided into individual chips. Alternatively the silicon wafer 21 can be divided into individual chips during the etching process. The fabrication of cells with interior volumes below 0.01 mm³ is feasible with deep reactive ion etching techniques. In an alternative embodiment, the holes 20 can be formed in the silicon wafer 21 by drilling through the wafer 21 with a diamond drill or an acoustic machining. Materials other than silicon are also suitable for use as the wafer, including other semiconductors, quartz, fused silica, glasses and metals.

After formation of the holes 20, a thin Pyrex wafer (or other window materials that is at least semitransparent) 22 is anodically bonded to one side of the silicon wafer 21 creating a cell preform which is open at one end as shown in FIG. 8b. The mention of Pyrex as the window material is by way of example only; other similar glasses or semiconductors could be suitable. The cell requires at least one transparent or semitransparent window that allows the laser light to interact with the alkali atoms. In one experimental example conducted during the course of the present invention a thin Pyrex wafer 22 was anodically bonded to a silicon wafer 21 (with holes therein) at a temperature of about 300° C. while applying a voltage of about 1200 V for several minutes. Bonding at lower temperatures can also be achieved by lengthening the bonding time appropriately.

In the fabrication step depicted in FIG. 8c the preform is filled with an alkali metal, such as Cs, Rb or K, or a material that reacts to produce such a metal. Several methods that can be used to fill the cell are discussed in more detail below.

After the preform is filled with an alkali metal (and optional buffer gas), the final step in the cell fabrication process which is depicted in FIG. 8d is to anodically bond a Pyrex wafer 23 on the open end of the preform, thereby sealing the alkali metal inside the cell. This final bonding step can be carried out either under vacuum or in a buffer-gas environment consistent with the requirements for application of the cells in an atomic clock or magnetometer.

Introducing the alkali metal into the cell can be accomplished in several ways, two of which are described in the examples below. In the first process, the preform is placed in a commercially available anaerobic chamber containing a gas or gases that do not react with alkali metals such as dry nitrogen, Ar, Ne, etc. Trace amounts of oxygen inside the chamber are removed via catalytic reactions with an anaerobic gas mixture and a catalyst (palladium). The catalytic reactions reduce the oxygen to form water vapor, which is then absorbed by the system's drying system. This method of producing a controlled, oxygen- and water-free environment is well-documented and highly developed. Within the anaerobic chamber, a micropipette is used to dispense liquid cesium into the holes of the perform which serve as reservoirs. The preform is then placed inside a vacuum chamber containing the anodic bonding apparatus. The vacuum chamber is evacuated, back-filled with a buffer gas at a desired pressure and the second Pyrex wafer is then bonded onto the top of the preform using anodic bonding, sealing the alkali metal (Cs or Rb) and buffer gas inside the cell. Cs and Rb can be identified as shiny, metallic-looking particles inside the cell. The entire cell fabrication, filling and sealing process can be performed in a rapid and repeatable manner.

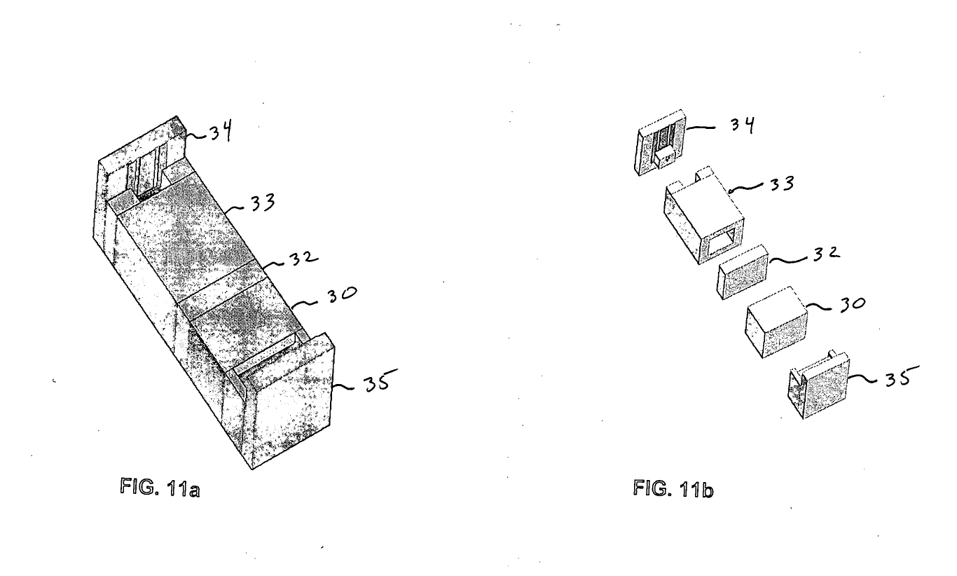

The above-described process was used to fabricate a Cs filled cell in which the presence of atomic Cs was confirmed together with the approximate pressure of the appropriate buffer gas by optical absorption measurement. The broadening of the optical absorption spectrum of a cell fabricated using a similar procedure is shown in FIG. 9 which is a graph of the optical absorption spectrum of a Cs cell fabricated in an anaerobic chamber. The broad absorption line indicates the presence of not only Cs vapor but also the presence of a substantial amount of nitrogen buffer gas. From FIG. 9 the pressure of the nitrogen contained inside the cell with the Cs is determined to be about 200 Torr which is appropriate for use in a frequency reference.

The anodic bonding method can be used in conjunction with another filling process for making alkali atom cells. This alternative process involves the reaction:
Ba₂N₆₊₂(Alkali)Cl→2BaCl+3N₂₊₂(Alkali),
where Alkali represents and alkali element such as Cs or Rb.

In one experimental example conducted during the course of the present invention the salt CsCl is added to a 15% solution of Ba₂N₆ in H₂O. This mixture was introduced into a cell preform and baked in air to evaporate the water. When the residue (CsCl+Ba₂N₆) was heated under vacuum to roughly 120° C., the Ba₂N₆ decomposed into elemental Ba and N₂ gas. At a somewhat higher temperature (near 200° C.), the Ba reacted with the CsCl to produce BaCl and elemental Cs. The N₂ released can in principle serve as a buffer gas in the final cell. However, a large amount of the gas is created relative to the amount of Cs and if the N₂ pressure in the final cell is too high (above a few tens of kPa), the optical transitions in the Cs atoms are overly broadened and the cell becomes hard to use in clock applications.

In order to control the amount of N₂ in the final cell the Ba₂N₆ was reacted before the final cell window was bonded. After filling the preform with the Ba₂N₆+CsCl mixture and drying, the preform was placed in an ultra-high vacuum (UHV) system, which was then evacuated. The preform was heated to 150° C. and left for at least 60 minutes to allow the Ba₂N₆ to decompose and most of the N₂ to disperse. The Pyrex wafer was then pushed up against the preform top within the vacuum system and the bonding voltage was applied. The temperature was then increased slowly to allow the anodic bonding to happen before the CsCl is reduced so that the final Cs product is contained inside the cell. It was determined that if the bonding does not occur at a low enough temperature, any Cs can escape from the cell or be internally reacted to a non-useful compound.

After removal from the vacuum system, an optical absorption resonance was measured by passing light from a vertical-cavity surface-emitting laser through cell and scanning the laser wavelength over the Cs absorption line. This absorption spectrum is shown in FIG. 10. The amount of absorption is consistent with what is expected from the vapor pressure of Cs at 79° C. in a cell of 350 μm length. In addition, it can be seen that the widths of the optical absorption lines are essentially Doppler-limited, indicating that the pressure of any buffer gas inside the cell is less than a few hundreds of Pa. It therefore can be concluded that the N₂ produced during the reaction was removed from the cell before bonding. By backfilling the UHV chamber with an appropriate pressure of a desired buffer gas, cells with narrow resonance line-widths suitable for use in atomic frequency references have been made according to the present invention. These measurements all demonstrate the viability of the design and fabrication methods described herein.

Another method of filling cells with alkali metal involves the use of a beam of alkali atoms formed using an alkali oven and collimation apertures. Such a beam in a UHV environment can be used to deposit an alkali metal film directly inside a preform, and the chamber could then be backfilled with a buffer gas. The cells would be sealed in the same manner as in the previous filling methods, using a second glass wafer and anodic bonding. This method has the advantage that all the alkali-metal handling is done inside a UHV system, and cleaner and higher-purity alkali metal could be obtained.

Cells fabricated from silicon wafers as described above can be easily integrated into physics packages for compact atomic clocks. One such design is exemplified in FIG. 11. In this design, the alkali cell 30 is first fabricated using one of the methods described above. The cell 30 could of course be fabricated at the wafer level, with many cells made with the same process sequence. A series of diffractive (or refractive) lenses 31 can be lithographically patterned on the exterior glass surface, one lens centered on each cell. The lenses 31 can be used to collimate diverging light (from a laser, for example) incident on the cell. A quartz wafer can be bonded onto the cell to form a waveplate 32 that can rotate the polarization of the light into a suitable state. A spacer assembly (also made at the wafer level) 33 can bonded onto the quartz wafer Next a laser assembly 34 consisting for example of a vertical cavity surface emitting laser bonded onto a mounting structure can attached to the spacer unit. Finally a detector assembly 35 can bonded to the opposite side of the cell to detect the light from the laser that is transmitted through the cell.

The physics package depicted in FIG. 11 can include a diffractive lens patterned on one of the glass surfaces to collimate light from the laser or a small refractive lens to collimate light from the laser. Additionally, carbon can be deposited on one of the glass surfaces to attenuate light from the laser or an optically dense glass could be used. It is also possible to incorporate heaters comprising a pattern of conductive material such as indium-tin-oxide on the cell window faces or on another surface in the structure in order to heat the cell to a desired temperature. It is also possible to pattern magnetic materials or gold loops on the cell faces or on another surface in the structure and pass a current through the loops to create a magnetic field inside the cell.

By using silicon micromachining technologies according to the present invention the vapor filled cells can be batch fabricated at lower costs and in smaller sizes. Since the processes of the present invention use of the same manufacturing platform as microelectronics and MEMS it is possible to integrate the vapor filled cells in substrates together with control electronics and sensors

The entire fabrication-filling-sealing process can in principle be performed at the wafer level and at low costs. Silicon etching and anodic bonding have already been demonstrated in industry at the wafer level. Cell filling can be performed at the wafer level with either of the filling techniques described in above. For the anaerobic chamber technique, micropipettes are commercially available with manifolds containing arrays of pipette tips which allow simultaneously filling an array of cell preforms in one dispensing action. For the chemical reaction technique, an appropriate concentration of the Ba₂N₆(Alkali)Cl mixture could be used to fill all wafer level preforms, with the drying, heating and bonding performed subsequently for all cells. For atomic beam deposition of alkali metal, a large-diameter atomic beam could be used to fill all cells on a wafer simultaneously. Thermal control of the cell preform during the filling process maybe required.

The use of catalytic reactions to achieve a controlled oxygen free environment has been used broadly in industrial applications for about two decades and is relatively low-cost as compared to using UHV. All materials used to fabricate the vapor cells according to the present invention are readily commercially available.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above.

1. A method of fabricating compact cells containing alkali atom vapor which comprises the following steps:
a) forming an cell having a volume of 1 cm³ or less and an opening therein;
b) filling the cell with alkali atoms; and
c) sealing the opening of the cell, wherein the completed cell has at least one window thorough which irradiation can pass in order to react with the alkali atoms within the cell.

2. The method of fabricating compact cells containing alkali atom vapor according to claim 1, wherein the filling of the cell in step b) and the sealing of the cell in step c) are conducted in a chamber having a controlled environment that contains alkali atoms.

3. The method of fabricating compact cells containing alkali atom vapor according to claim 1, wherein the filling of the cell in step b) comprises filling the cell with alkali atoms and a buffer gas.

4. The method of fabricating compact cells containing alkali atom vapor according to claim 2, wherein the controlled environment contains alkali atoms and a buffer gas so that the cell is filled with alkali atoms and the buffer gas.

5. The method of fabricating compact cells containing alkali atom vapor according to claim 1, wherein the filling of the cell in step b) and the sealing of the cell in step c) are conducted by placing an alkali metal in the cell, placing the cell in a chamber containing a buffer gas and sealing the cell in the chamber.

6. The method of fabricating compact cells containing alkali atom vapor according to claim 1, wherein the filling of the cell in step b) comprises placing reactants in the cell which are capable of reacting to produce alkali atoms and reacting the reactants to form alkali atoms in the cell.

7. The method of fabricating compact cells containing alkali atom vapor according to claim 6, wherein the reactants also form a buffering gas.

8. The method of fabricating compact cells containing alkali atom vapor according to claim 1, wherein the filling of the cell in step b) comprises using an atomic beam to fill the cell with alkali atoms.

9. The method of fabricating compact cells containing alkali atom vapor according to claim 1, wherein the cell is formed in step a) and sealed in step c) using anodic bonding.

10. The method of fabricating compact cells containing alkali atom vapor according to claim 9, wherein the cell is formed in step a) by providing a silicon wafer with a hole there through and bonding a glass plate to one side of the silicon wafer to close one end of the hole.

11. The method of fabricating compact cells containing alkali atom vapor according to claim 10, wherein the cell is sealed in step c) by bonding another glass plate to another side of the silicon wafer to seal the hole.

12. The method of fabricating compact cells containing alkali atom vapor according to claim 9, wherein the cell is formed by providing a silicon wafer with a formed recess that does not extend through the wafer and bonding a transparent or semitransparent window on the silicone wafer to seal the recess.

13. The method of fabricating compact cells containing alkali atom vapor according to claim 1, wherein the cell comprises a hollow tube that is sealed by irradiation.

14. The method of fabricating compact cells containing alkali atom vapor according to claim 13, wherein the sealed portion of the hollow tube comprises a lens through which irradiation can enter the hollow tube.

15. The method of fabricating compact cells containing alkali atom vapor according to claim 13, wherein the filling of the cell in step b) comprises connecting a filling tube to the cell.

16. A physics package for an atomic frequency reference, that comprises an alkali vapor filled cell having a volume of 1 cm³ or less, which alkali vapor filled cell is produced by the steps of:
a) forming an cell having a volume of 1 cm³ or less and an opening therein;
b) filling the cell with alkali atoms; and
c) sealing the opening of the cell.

17. A physics package for an atomic frequency reference according to claim 16 which further comprises:
a laser;
a photodiode; and
a microoptics arrangement for trapping a coherent population and exciting atomic microwave resonance.

18. A physics package for an atomic frequency reference according to claim 17, wherein the alkali vapor filled cell is optically positioned between the laser and the photodiode so that a light beam from the laser is perpendicular to the sealed opening of the cell.

19. A physics package for an atomic frequency reference according to claim 16, wherein the entire physics package is formed of a common wafer substrate.

20. A physics package for an atomic frequency reference according to claim 16, wherein the entire physics package is assembled in a semi-monolithic assembly.

21. A physics package for an atomic frequency reference according to claim 19, further comprising:
a light source;
at least one of a diffraction lens and a refractive lens to collimate a light beam produced by the light source; and
a photodetector.

22. A physics package for an atomic frequency reference according to claim 21, further comprising:
means selected from a deposition of carbon or an optically dense glass for attenuating light that is directed on the alkali vapor filled cell from the light source.

23. A physics package for an atomic frequency reference according to claim 21, further comprising:
at least one of a heating element to heat the alkali vapor filled cell and a electromagnet to create a magnetic field.
